(19) United States
(12) Patent Application Publication
(10) Pub. No.: US 2009/0291385 A1
(43) Pub. Date: Nov. 26, 2009

(54) IMAGE FORMING APPARATUS AND METHOD OF FORMING COLOR IMAGE USING THE SAME

(75) Inventor: Ji-won JEONG, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (JP)

(21) Appl. No.: 12/399,080

(22) Filed: Mar. 6, 2009

(30) Foreign Application Priority Data
May 23, 2008 (KR) 10-2008-0048065

(51) Int. Cl. G03G 13/20; G03G 15/01

(52) U.S. Cl. 430/124.1; 399/223

(57) ABSTRACT

Provided are an image forming apparatus and a method of forming a color image using the same. The image forming apparatus including an image forming medium which includes a plurality of cells, wherein each cell operates independently, and the cells are charged according to a color image to be recorded, thereby forming a latent image; a developing unit which includes a plurality of toner cartridges, wherein the toner cartridges are aligned around a circumference of the image forming medium and spaced apart from each other at predetermined intervals, and contains different color toners that are used to develop the latent image into the color image; a transferring unit which transfers the color image to a recording medium; and a fixing unit which fixes the color image transferred to the recording medium, wherein the latent images are developed with different color toners, according to the order in which the cells face the toner cartridges.

### CROSS-REFERENCE TO RELATED PATENT APPLICATIONS

This application claims priority from Korean Patent Application No. 10-2008-0048065, filed on May 23, 2008, in the Korean Intellectual Property Office, the disclosure of which is incorporated herein in its entirety by reference.

### BACKGROUND OF THE INVENTION

1. Field of the Invention

Methods and apparatuses consistent with the present invention relate to formation of color images, and more particularly, to forming a latent image on an image forming medium, developing the latent image, transferring the developed image to a recording medium, and fixing the transferred image on the recording medium.

2. Description of the Related Art

Generally, an electrophotographic image forming apparatus forms images using the following method. An image forming medium whose entire surface is charged with a predetermined polarity is exposed to light according to image data to be recorded so as to form a latent image on the surface of the image forming medium. Then, the latent image is developed with a developer, such as toner, to form a developed image. The developed image is transferred to a recording medium and the transferred image is fixed on the recording medium, thereby completing the formation of an image on the recording medium.

As described above, to form images, conventional electrophotographic image forming apparatuses necessarily require an apparatus and process for charging the entire surface of an image forming medium with a predetermined polarity, and a process for exposing the surface of the image forming medium. Due to such necessary requirements, there is a limit to reducing time required for data printing.

Conventional electrophotographic color image forming systems can be categorized into multi-pass type color image forming systems and single-pass type color image forming systems.

In multi-pass type color image forming systems, cyan toner, magenta toner, yellow toner, and black toner are sequentially applied to an image forming medium to develop a latent image. That is, only one image forming medium is treated with four toners.

In single-pass type color image forming systems, each of cyan toner, magenta toner, yellow toner, and black toner is applied to respective image forming media to develop a latent image. That is, four drums which are aligned with each other are used to form color images.

However, in a multi-pass type color image forming system, a developing rate is low due to the sequential treatment with four colors. In addition, in a single-pass type color image forming system, four sets of image forming media and developing devices are required for the four colors and thus, additional components are required and the apparatus structure is complex, and the manufacturing costs are high.

### SUMMARY OF THE INVENTION

Exemplary embodiments of the present invention provide an image forming apparatus for forming a color image using an image forming medium including a plurality of cells, in which the cells are disposed in a matrix and each cell operates independently without a photoreceptor, and different color toners are sequentially attached in a multi-layer structure to the cells while the amount of the charge applied to the cells is gradually increased.

Exemplary embodiments of the present invention also provide a method of forming a color image using the image forming apparatus.

According to an aspect of the present invention, there is provided image forming apparatus including: an image forming medium which has a surface comprising a plurality of cells, wherein each cell operates independently, and the cells are charged according to a color image to be recorded so as to form latent images; a developing unit which comprises a plurality of toner cartridges containing different color toners, wherein the toner cartridges are aligned around the image forming medium and spaced apart from each other at predetermined intervals, and which develops the latent image into the color image; a transferring unit which transfers the color image to a recording medium; and a fixing unit which fixes the color image that has been transferred to the recording medium, wherein the latent images are developed with different color toners, according to the order in which the cells face the toner cartridges.

According to another aspect of the present invention, there is provided method of forming a color image, the method including: forming a latent image by charging a plurality of cells to have an opposite polarity to an original polarity of the cells according to an order in which the cells face a plurality of toner cartridges containing different color toners; developing the latent image with a corresponding color toner to develop a color image;

transferring the developed color image to a recording medium; and fixing the transferred color image on the recording medium.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of an image forming apparatus according to an exemplary embodiment of the present invention;

FIG. 2 is a sectional view of the image forming apparatus of FIG. 1, according to an exemplary embodiment of the present invention;

FIGS. 3A-3E are views illustrating an operation of developing a latent image into a color image on a circumferential surface of an image forming apparatus;

FIG. 4 is a perspective view of one of a plurality of cells constituting a peripheral portion of an image forming medium of the image forming apparatus illustrated in FIGS. 1 and 2, according to an exemplary embodiment of the present invention;

FIG. 5 is a view illustrating the structure of the cell of FIG. 4, according to an exemplary embodiment of the present invention;

FIGS. 6 and 7 are views for explaining a method of changing polarity of the cells illustrated in FIG. 3A, according to an exemplary embodiment of the present invention; and

FIG. 8 is a flow chart illustrating a method of forming a color image by using an image forming apparatus according to the present invention, according to an exemplary embodiment of the present invention.

### DETAILED DESCRIPTION OF EXEMPLARY EMBODIMENTS OF THE INVENTION

The present invention will now be described more fully with reference to the accompanying drawings, in which exemplary embodiments of the invention are shown.

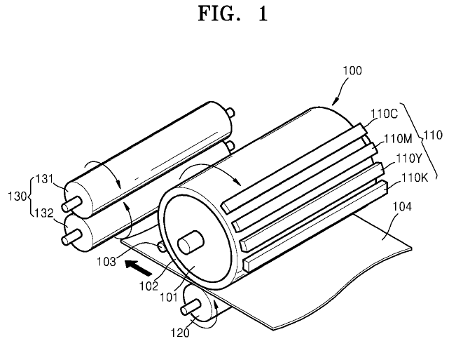

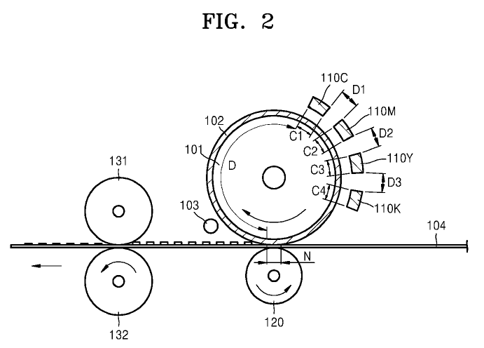

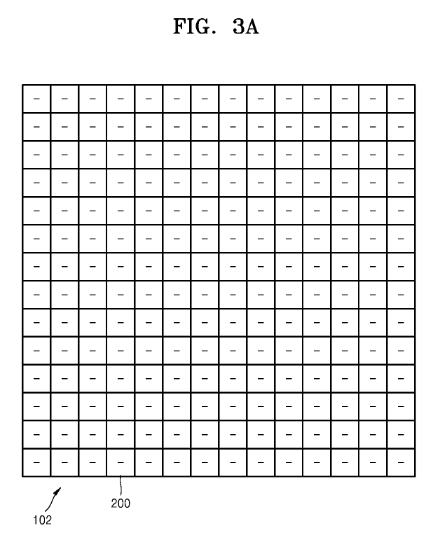

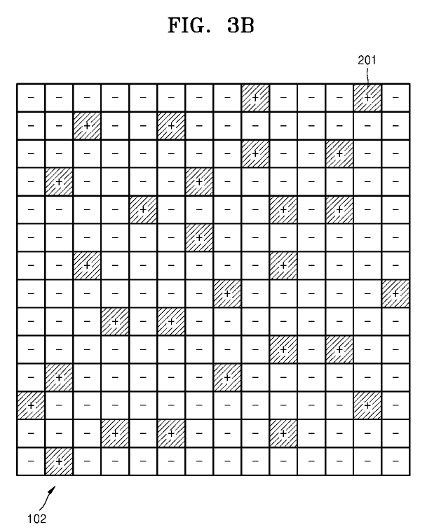

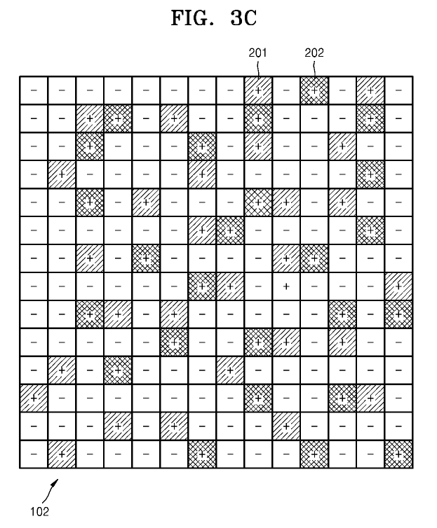

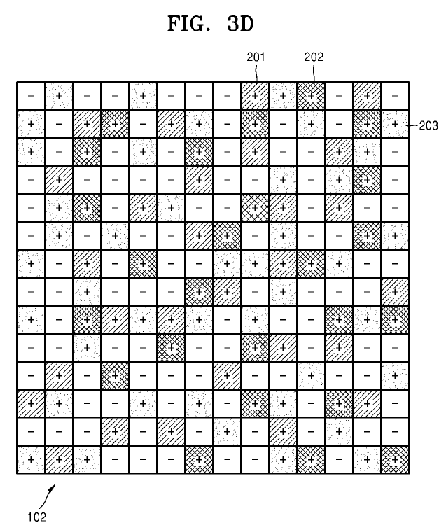

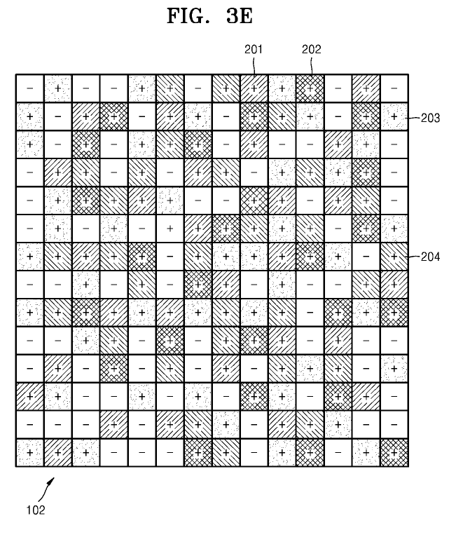

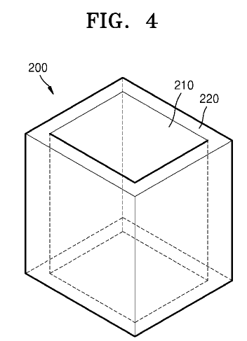

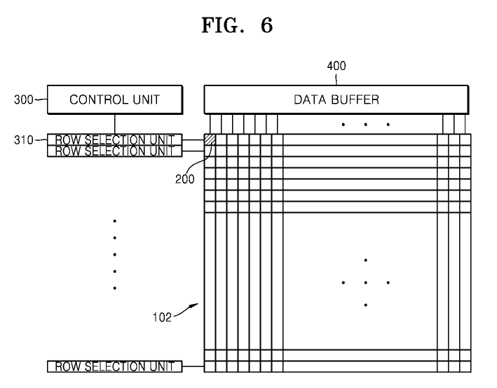

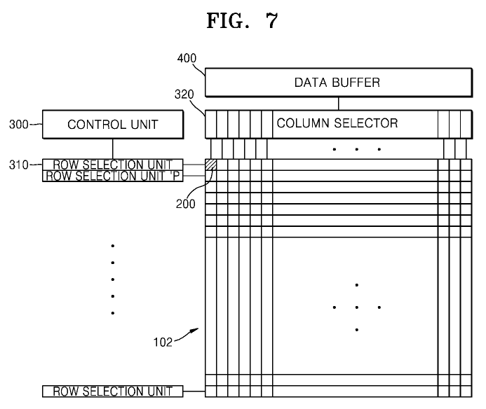

FIG. 1 is a perspective view of an image forming apparatus according to an exemplary embodiment of the present invention, FIG. 2 is a sectional view of the image forming apparatus of FIG. 1, FIGS. 3A-3E are views illustrating an operation of developing a latent image into a color image on a circumferential surface of an image forming apparatus, FIG. 4 is a perspective view of one of a plurality of cells constituting a peripheral portion of the image forming medium illustrated in FIGS. 1 and 2, FIG. 5 is a view illustrating the structure of the cell of FIG. 4, and FIGS. 6 and 7 are views for explaining a method of changing polarity of the cells illustrated in FIG. 3A, according to an exemplary embodiment of the present invention.

Referring to FIGS. 1-2, the image forming apparatus according to the current exemplary embodiment includes an image forming medium 100 having a circumference including a plurality of cells 200 (FIGS. 3A-3D) for forming a latent image, a cleaning unit 103 initiating a surface potential of the image forming medium 100, a developing unit 110 developing the latent image into a color image, a transferring unit 120 transferring the developed color image to a recording medium 104, a fixing unit 130 fixing the transferred color image on the recording medium 104, and a control unit 300 (FIG. 6) controlling polarity of the cells 200 (FIGS. 3A-3D) according to a color image to be recorded.

The image forming medium 100 may be a cylindrical photoreceptor. The image forming medium 100 includes a rotary body 101, and a peripheral portion 102 disposed on a circumferential surface of the rotary body 101, wherein the peripheral portion 102 includes the cells 200 (FIGS. 3A-3D) that are arranged in a matrix. The peripheral portion 102 can be formed in such a way that the cells 200 (FIGS. 3A-3D) are formed using a flexible material and then the rotary body 101 is wound with the cells 200 (FIGS. 3A-3D). The image forming medium 100 can also be a belt-type drum.

Referring to FIG. 4, each cell 200 includes a space portion 210 having a predetermined depth and a partition wall 220 having a predetermined thickness surrounding the space portion 210. The partition wall 220 is formed of a non-conductive material. In the cell 200, an x-axis length and a y-axis length may be dependent upon an output resolution (horizontal units x vertical units). For example, if the output resolution is 1200 dpi, each of the x-axis length and the y-axis length may be 0.02 mm (1/1200×25.4). In addition, the x-axis length and the y-axis length are also dependent upon the size of the partition wall 220, wherein the partition wall 220 separates adjacent cells 200 from each other so that a cell 200 charged by a condenser does not affect a charge state of its neighboring cell 200.

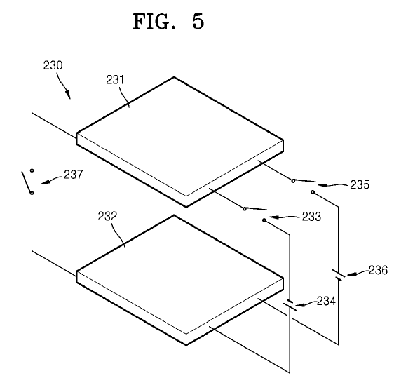

A device that can change polarity of the cell 200 is disposed in the space portion 210 of the cell 200. The device may be a condenser 230 illustrated in FIG. 5. The condenser 230 includes a first plate 231, a second plate 232, and a dielectric (not shown) interposed between the first plate 231 and the second plate 232. The first plate 231 partially constitutes a surface of the image forming medium 100. The first plate 231 and the second plate 232 are connected to a first charge switch device 233 and a second charge switch device 235. The first charge switch device 233 may connect the first plate 231 and the second plate 232 to a power source 234 or disconnect the first plate 231 and the second plate 232 from the power source 234 so that the first plate 231 is positively charged and the second plate 232 is negatively charged. The second charge switch device 235 may connect the first plate 231 and the second plate 232 to a power source 236 or disconnect the first plate 231 and the second plate 232 from the power source so that the first plate 231 is negatively charged and the second plate 232 is positively charged. Accordingly, the first plate 231 and the second plate 232 can be positively or negatively charged by selectively operating the first charge switch device 233 and the second charge switch device 235. Meanwhile, toner that is to be attached due to an electrostatic phenomenon may have an opposite polarity to polarity of the first plate 231 and the second plate 232. In the current exemplary embodiment, the first plate 231 is positively charged and toner is negatively charged. In addition, the first plate 231 can be coated with a specific material, that is, a material inducing static electricity to prevent abrasion or increase static electricity.

The first plate 231 and the second plate 232 are also connected to an initializing switching device 237. The initializing switching device 237 connects the first plate 231 to the second plate 232 and neutralizes each of the first and second plates 231 and 232.

Accordingly, when the first and second charge switching devices 233 and 235 are turned on, the initializing switching device 237 is turned off. On the other hand, when the initializing switching device 237 is turned on, the first and second charge switching devices 233 and 235 are turned off.

The first and second charge switching devices 233 and 235 and the initializing switching device 237 can be various types of devices that can cause electrostatic phenomena and can be controlled according to a signal applied thereto.

As described above, an image forming medium used according to the exemplary embodiment of the present invention has a different structure from that of conventional photoreceptors and can change its polarity by itself. In this aspect, the image forming medium used according to the exemplary embodiment of the present invention can be referred to as a self image forming medium.

The developing unit 110 includes a plurality of toner cartridges which are spaced apart at predetermined intervals and are sequentially aligned round the image forming medium 100. The toner cartridges include a cyan toner cartridge 110C containing cyan toner, a magenta toner cartridge 110M containing magenta toner, a yellow toner cartridge 110Y having yellow toner, and a black toner cartridge 110K storing black toner. Toners contained in the cyan, magenta, yellow and black toner cartridges 110C, 110M, 110Y, and 110K may have a negative charge (−).

In FIG. 2, C1, C2, C3 and C4 respectively denote areas of the image forming medium 100 facing the cyan, magenta, yellow and black toner cartridges 110C, 110M, 110Y, and 110K. The cyan toner cartridge 110C is spaced apart from the magenta toner cartridge 110M by a distance D1, the magenta toner cartridge 110M is spaced apart from the yellow toner cartridge 110Y by a distance D2, and the yellow toner cartridge 110Y is spaced apart from the black toner cartridge 110B by a distance D3. In FIG. 2, D denotes a circumference of the image forming medium 100 starting from a nip N to the cyan toner cartridge 110C. The nip N is formed when the image forming medium 100 contacts the transferring unit 120. The alignment order of the cyan, magenta, yellow and black toner cartridges 110C, 110M, 110Y, and 110K, the areas C1, C2, C3 and C4, and the distances D1, D2, and D3 may differ according to characteristics of the image forming apparatus.

The transferring unit 120 transfers a color image formed by the developing unit 110 to the recording medium 104. Specifically, when the transferring unit 120 passes the nip N formed between the transferring unit 120 and the image forming medium 100, a portion of the image forming medium 100 passing the nip N is charged with such polarity that the toner forming the color image is detached. Thus, a repulsion force is generated between the image forming medium 100 and the toner forming the color image, and the transferring unit 120 is charged with a polarity so as to attract the toner forming the color image so that an attraction force is generated between the transferring unit 120 and the toner forming the color image. For example, the portion of the image forming medium 100 passing the nip N may be charged with a negative charge (−) and the transferring unit 120 may be charged with a positive charge (+). The transferring unit 120 may be a transfer roller.

The fixing unit 130 fixes the color image that has been transferred to the recording medium 104 by the transferring unit 120. The fixing unit 130 includes a heating roller 131 generating heat, and a pressing roller 132 facing the heating roller 131 and applying pressure. Accordingly, the color image passing through between the heating roller 131 and the pressing roller 132 is heated and pressed and thus fixed on the recording medium 104.

The cleaning unit 103 removes the residual toner on the surface of the image forming medium 100 after the transferring unit 120 completely transfers the color image. In fact, however, the transferring unit 120 cannot completely transfer the color image and a predetermined amount of toner necessarily remains on the surface of the image forming medium 100. Since the residual toner degrades the image quality in the subsequent printing process, the residual toner should be removed to obtain high image quality after the transferring process is completely performed. To this end, an electrical state of the surface of the image forming medium 100 is initialized to remove the residual toner on the surface of the image forming medium 100. For example, a portion of the image forming medium 100 on which toner remains is neutralized so that negatively charged toner is easily removed from the image forming medium 100.

The control unit 300 changes polarities of the cells 200 using a line control mode as illustrated in FIG. 6 or a cell control mode as illustrated in FIG. 7 to form a latent image.

In the line control mode as illustrated in FIG. 6, a row selection unit 310 is installed at every row line, a line address is decoded and the decoded line address is transmitted to all row selection units 310, and each row selection unit 310 selects the corresponding row line and charges the cells according to image information about the corresponding row line in a data buffer 400.

In the cell control mode as illustrated in FIG. 7, a row selection unit 310 is installed at every row line, a column selection unit 320 is installed at every column line, a line address is decoded and the decoded line address is transmitted to all row selection units 310 and all heat selection units 320, and each row selection unit 310 and each heat selection unit 320 select the corresponding cell and charge the selected cell with the corresponding cell information in the data buffer 400.

Hereinafter, a method of forming a color image using the image forming apparatus according to the present invention will now be described in detail.

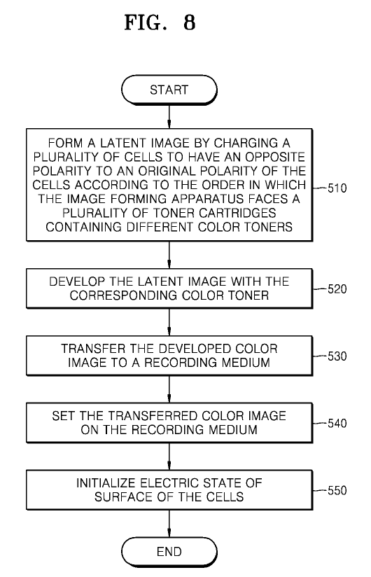

Referring to FIGS. 2, 3A-3D, and 8, as the cyan, magenta, yellow and black toner cartridges 110C, 110M, 110Y, and 110K are sequentially passed by the image forming medium 100, cells 200 that are to be developed with different color toners are charged with an opposite polarity to an original polarity of the cells 200, thereby forming a latent image (Operation 510 of FIG. 8).

After Operation 510, the latent image is developed with the corresponding color toner and the color image is formed on the image forming medium 100 (Operation 520 of FIG. 8).

Operation 510 and Operation 520 will now be described in detail.

Referring to FIG. 3A, the image forming medium 100 is initialized so that the cells 200 are charged to have a negative charge (−).

Referring to FIG. 3B, cells 201 to which cyan toner is to be attached are charged with a positive charge (+) immediately before the cells 201 arrive at the area C1 (see FIG. 2). Then, when the cells 201 pass the area C1, cyan toner having a negative charge (−) contained in the cyan toner cartridge 110C is attached to the cells 201 and the latent image is developed. The positive (+) polarity of the cells 201 that are once developed with cyan toner may be maintained constant until the cells 201 pass by the transferring unit 120.

Referring to FIG. 3C, cells 202 to which magenta toner is to be attached are charged with a positive charge (+) immediately before the cells 202 arrive at the area C2 (see FIG. 2) and a latent image is formed. That is, the cells 202 is charged in the area D1 (see FIG. 2). Then, when the cells 202 pass the area C2, magenta toner having a negative charge (−) contained in the magenta toner cartridge 110M is attached to the cells 202 and the latent image is developed. The positive (+) polarity of the cells 202 that are once developed with magenta toner may be maintained constant until the cells 202 pass by the transferring unit 120.

Referring to FIG. 3D, cells 203 to which yellow toner is to be attached are charged with a positive charge (+) immediately before the cells 203 arrive at the area C3 (see FIG. 2) and a latent image is formed. That is, the cells 203 is charged in the area D2 (see FIG. 2). Then, when the cells 203 pass the area C2, yellow toner having a negative charge (−) contained in the yellow toner cartridge 110Y is attached to the cells 203 and the latent image is developed. The positive (+) polarity of the cells 203 that are once developed with yellow toner may be maintained constant until the cells 203 pass by the transferring unit 120.

Referring to FIG. 3E, cells 204 to which black toner is to be attached are charged with a positive charge (+) immediately before the cells 204 arrive at the area C4 (see FIG. 2) and a latent image is formed. That is, the cells 204 is charged in the area D3 (see FIG. 2). Then, when the cells 204 pass the area C2, black toner having a negative charge (−) contained in the black toner cartridge 110K is attached to the cells 204 and the latent image is developed. The positive (+) polarity of the cells 204 that are once developed with black toner may be maintained constant until the cells 204 pass by the transferring unit 120.

As described above, when the image forming medium 100 passes by the cyan, magenta, yellow and black toner cartridges 110C, 110M, 110Y, and 110K, the cyan toner 111, a latent image is developed and a color image to be recorded is formed on the image forming medium 100.

In this regard, once color toner is attached to a cell and the cell is developed, static electricity that allows other color toner to be attached to the color toner that has been attached to the cell is not generated even when the cell passes by a toner cartridge containing the other color toner. Therefore, even when a cell to which one type of color toner is attached continually has a positive (+) charge, other color toner may not be attached to the toner.

After Operation 520, when the color image formed on the surface of the image forming medium 100 passes through the nip N between the transferring unit 120 and the image forming medium 100, the color image is transferred to the recording medium 104 due to a static electricity (Operation 530 of FIG. 8).

After Operation 530, when the color image transferred to the recording medium 104 passes the fixing unit 130, the color image is fixed on the recording medium 104 (Operation 540 of FIG. 8).

After Operation 540, when the image forming medium 100 passes by the cleaning unit 103, the cleaning unit 103 neutralizes an electrical state of the cell 200 (Operation 550 of FIG. 8).

As described above, an image forming apparatus and a method of preparing the same according to the exemplary embodiments of the present invention have the following effects.

First, latent images of a plurality of cells, each operating independently, can be developed in different color in the order in which the cells face the toner cartridges. Therefore, a color image forming rate can be increased.

Second, polarity of the cells of an image forming medium can be self-changed and a latent image can be formed independently. Therefore, the structure of apparatus can be simplified and miniaturized.

Third, the miniaturization of the apparatus and the number of necessary components is reduced. Therefore, the manufacturing costs can be lowered.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An image forming apparatus comprising:
an image forming medium which has a surface comprising a plurality of cells, wherein each cell operates independently, and the cells are charged according to a color image to be recorded so as to form latent images;
a developing unit which comprises a plurality of toner cartridges containing different color toners, wherein the toner cartridges are aligned around the image forming medium and spaced apart from each other at predetermined intervals, and which develops the latent image into the color image;
a transferring unit which transfers the color image to a recording medium; and
a fixing unit which fixes the color image that has been transferred to the recording medium, wherein
the latent images are developed with different color toners according to the order in which the cells face the toner cartridges.

2. The image forming apparatus of claim 1, wherein the cells form a latent image immediately before the cells face a toner cartridge having toner corresponding to a color image to be recorded.

3. The image forming apparatus of claim 2, wherein the cells are charged in an area between adjacent toner cartridges to form a latent image that is to be developed with toner of a toner cartridge the cells are about to face.

4. The image forming apparatus of claim 1, wherein a cell on which a latent image is developed, with a corresponding toner of a toner cartridge by which the cell has passed, has constant polarity.

5. The image forming apparatus of claim 1, further comprising a cleaning unit which neutralizes an electrical state of the cells after the transferring unit transfers the color image.

6. The image forming apparatus of claim 1, further comprising a control unit which changes a polarity of the cells according to a color image that is to be recorded.

7. A method of forming a color image, the method comprising:
forming a latent image by charging a plurality of cells to have an opposite polarity to an original polarity of the cells according to an order in which the cells face a plurality of toner cartridges containing different color toners;
developing the latent image with a corresponding color toner to develop a color image;
transferring the developed color image to a recording medium; and
fixing the transferred color image on the recording medium.

8. The method of claim 7, wherein, in developing the latent image, the cells form the latent image immediately before the cells face a toner cartridge containing toner corresponding to a color image to be recorded.

9. The method of claim 8, wherein, in forming the latent image, the cells are charged in an area between adjacent toner cartridges to form a latent image that is to be developed with toner of a toner cartridge the cells are about to face.

10. The method of claim 7, wherein, in developing the latent image, when a cell on which a latent image is developed, with a corresponding toner of a toner cartridge by which the cell has been passed, the cell maintains constant polarity.

11. The method of claim 8, further comprising, neutralizing an electrical state of the cells.

12. An image forming apparatus comprising:
an image forming medium which has a surface comprising a plurality of cells, wherein each cell operates independently, and the cells are charged according to a color image to be recorded so as to form latent images; and
a developing unit which comprises a plurality of toner cartridges containing different color toners, wherein the toner cartridges are aligned around the image forming medium and spaced apart from each other at predetermined intervals, and which develops the latent image into the color image, wherein
the latent images are developed with different color toners according to the order in which the cells face the toner cartridges.

13. The image forming apparatus of claim 12, wherein the cells form a latent image immediately before the cells face a toner cartridge having toner corresponding to a color image to be recorded.

14. The image forming apparatus of claim 13, wherein the cells are charged in an area between adjacent toner cartridges to form a latent image that is to be developed with toner of a toner cartridge the cells are about to face.

15. The image forming apparatus of claim 12, wherein a cell on which a latent image is developed, with a corresponding toner of a toner cartridge by which the cell has passed, has constant polarity.

16. The image forming apparatus of claim 12, further comprising a transferring unit which transfers the color image to a recording medium and a cleaning unit which neutralizes an electrical state of the cells after the transferring unit transfers the color image.

17. The image forming apparatus of claim 12, further comprising a control unit which changes a polarity of the cells according to a color image that is to be recorded.
